(19) United States
(12) Patent Application Publication
(10) Pub. No.: US 2002/0042875 A1
(43) Pub. Date: Apr. 11, 2002

(54) Method and apparatus for end-to-end secure data communication

(76) Inventor: Jayant Shukla, Sierra Madre, CA (US)

Correspondence Address: JAYANT SHUKLA, 124 VISTA CIRCLE DRIVE, SIERRA MADRE, CA, 91024, US

(21) Appl. No.: 09/910,667

(22) Filed: Jul. 23, 2001

Related U.S. Application Data
(60) Provisional application No. 60/239,369, filed on Oct. 11, 2000.

(51) Int. Cl. H04L 9/00

(52) U.S. Cl. 713/151

(57) ABSTRACT

The disclosed invention is a new method and apparatus to achieve end-to-end secure communication over public and private networks. The method can provide security to all networked applications without any modifications to the applications. The method is compatible with other networking protocols, such as, network address translation (NAT), Internet control message protocol (ICMP), and all quality of service (QoS) protocols that operate up to the transport layer. Secure communication system based on other protocols such as IPSec cannot achieve end-to-end security, while remaining compatible with networking protocols such as NAT and ICMP.

### CROSS REFERENCE TO RELATED APPLICATIONS

This application is derived from the provisional patent application No. 60239369 filed on Oct. 11, 2001.

### BACKGROUND OF THE INVENTION

There are many real world situations when one would like to protect the information, in a two or multi-party communication, from an eavesdropper. For example, one might need to communicate between two stations over a link that is not secured. Cryptographic methods provide the means to protect such communication. By encrypting the data, one makes it an almost infeasible task for an unwanted third party to obtain the original data from the encrypted data. If only the encrypted data is transmitted over an insecure channel, then the original data or the information in the data is secure from an eavesdropper.

While cryptographic methods are used to secure the information, the communication is done using various data networking “equipment” and “protocols”. The open systems interconnect (OSI) [1] recommends a seven-layered model for networking (FIG. 3). The Internet Protocol (IP) is an example of such a protocol and it is used at the network layer (layer 3) of the OSI stack. FIG. 3 shows how the user data is packaged as it travels through the different layers of the network. Each layer adds its own fixed length header to the data before transmitting it to the next layer.

For a secure communication system, the encryption/decryption of the data has to be incorporated into one of the networking layers. Secure Socket Layer (SSL) [2] is an example of session layer (layer 5) protocol that can be used to provide security. The SSL is implemented between the application and the transport layer and is now being replaced by Transport Layer Security (TLS) [3][4]. The data from the application is intercepted by the SSL/TLS, encrypted if desired, and handed over to the transport layer for further processing. Similarly, the data from transport layer to the application too is intercepted, and decrypted if desired. SSL/TLS can be used to achieve end-to-end or application-to-application security.

There are two significant shortcomings of SSL/TLS protocol. First is that there is no mechanism to prevent the tempering of transport or network layer headers because these headers are not part of the authentication header (AH) of the SSL/TLS protocol. This weakness can be used to launch a denial of service (DoS) attack on a host in certain situations. The second problem is that there is not in-built mechanism in SSL/TLS to support virtual private network (VPN) functionality. A company may use a VPN over public networks, such as the Internet, to share resources of many local area networks (LANs). The use of VPNs provides a more efficient and cost effective way to share information within a company.

The IPSec [5] protocol was developed to address the shortcomings of SSL/TLS. In IPSec, the security is provided at the network layer (layer 3). IPSec can be used in either “Transport” or “Tunnel” mode. In the transport mode, the data packet up to the TCP header is encrypted and authenticated. In the tunnel mode, the complete IP packet is encrypted and authenticated and a new IP header is added to it. The transport mode of IPSec was designed to provide end-to-end security and the tunnel mode was designed to build VPNs. However, there are problems with IPSec that do not permit the use of IPSec for achieving end-to-end security over public networks.

The two biggest drawbacks of IPSec are its incompatibility with network address translation (NAT) [6][7] and ICMP [8]. IPSec also conflicts with quality of service (QoS) protocols and traffic shaping/monitoring services that operate up to layer four of the OSI stack. Content based switching and Integrated Services (IS) based QoS fall in this category.

The use of NAT is very wide spread as it helps to hide the internal IP address used in a LAN. The need to hide the internal IP address arises because of two reasons. The first reason is that hiding the IP address used in the LANs will prevent an outsider from targeting a specific machine on the network and exploiting its weaknesses to gain unauthorized access. The second reason is that the limited availability of IP address has forced the use of IP address in the LANs that cannot be visible on the public networks. In order to hide the IP address of the end-host, NAT may change the source IP address and port number of an outgoing IP packet at the gateway. It can also change the destination IP address and port number in an incoming IP packet. These changes require that the network and transport layer headers are visible to the NAT box. It may seem that the deployment of IPv6 will enable us to move away from NAT, but the fact that NAT provides a very simple and efficient method to hide and/or protect nodes on a network from outside attacks will ensure its use even in IPv6.

In IPSec, the transport layer header is encrypted in either “transport” or “tunnel” mode. Moreover, the header is at a different location (compared to a standard IP packet) due to the presence of the encapsulating security payload (ESP) header. One way to solve this IPSec and NAT incompatibility is to perform IPSec transform after NAT is done. Due to this reason, IPSec must be implemented at the gateway. For end-to-end security in a LAN, one can use IPSec in “transport” mode. For VPNs, IPSec can be used in “tunnel” mode at the gateway. In this scenario, the end-to-end security over public network is possible, but it doubles the computational load on the gateways as the packets have to be decrypted and encrypted. The overall computational load is tripled as the end-host also encrypts the data. This approach may provide application level end-to-end security, but still does not solve the true end-to-end secure VPN problem.

Another problem with IPSec is its incompatibility with ICMP. ICMP is an error reporting mechanism on IP packets by which the sender is notified about the unavailability of the destination host. Because ICMP messages are sent over the Internet, they are encapsulated in an IP packet. ICMP messages include the first sixty-four bits of the transport layer header, which contains the source and destination port numbers and sequence number fields. In IPSec, the transport layer header is offset because of the presence of the ESP header. This causes the ICMP error reporting mechanism to not work properly.

There are several efforts in the IETF community to overcome these limitations of IPSec, which include:

Realm-Specific IP (RSIP) [9] [12]

Share a limited pool of global IP addresses between local hosts

IPSec NAT traversal using [10]

IKE probe

IPSec SA traffic encapsulation

NAT translation keepalive heartbeat

Built-in NAT

UDP encapsulation

Encapsulate the original IP packet with new UDP and IP headers

Most of them only focus on resolving the IPSec incompatibility with NAT. These approaches do not solve the existing IPSec conflicts with other protocols completely. These solutions either add undesirable overhead in the form of increased packet size, increased complexity in the protocols, and incompatibility with other protocols. For example, we encounter the following problems in RSIP (which is currently the favored choice for resolving NAT and IPSec conflicts):

Unnecessary TCP wait time as TCP waits for some time after disconnecting a socket. During that time it does not allow the use of that socket. Because of this another host cannot immediately connect to the host using the same socket

Because different hosts may share the available public IP address, this creates an ambiguity for ICMP messages

Similarly IP packets fragments by intermediate routers may face an ambiguity in assembly. This can be particularly bad for VPNs

The end host has to keep track of local hosts and not use RSIP protocol for communication with them. This widens the rift between the LAN and IP security

The same problem makes RSIP conflict with multicast applications. It is possible that some end hosts are local while others are not

Scalability of RSIP is not very well understood. The extreme compute and resource intensive nature of this protocol is a serious concern that will hinder its scalability

UDP encapsulation is another approach that is being developed. In this approach a UDP header encapsulates the ESP payload to protect it from NAT. The authors have proposed to use a fixed UDP port number that will be assigned by IANA. One can also use variable UDP port number, but it only exacerbates the problems faced by this solution.

So far, the authors have only shown that IKE can work in a host-to-network connection using their approach. They have not shown how IKE will work in a VPN connection and how the data packets will be exchanged in a VPN connection. Even if they eventually manage to solve these problems, there are certain other drawbacks that make this solution very undesirable. The major drawbacks are.

Content based switching will not work because the control packet is encrypted

It requires that packets be sent regularly to keep the NAT entry alive

If variable UDP port numbers are used the one must keep track of all connections in order to uniquely assign UDP port numbers

It is still not an end-to-end solution as the security tunnel terminates at the IPSec gateway

It really complicates the support for QoS

Per flow based QoS is not possible if a fixed UDP port is used as the standard port number and protocol to application mapping is obfuscated

If variable UDP port number is used then the QoS protocols now must interact with security protocol to learn the port number translation in order to support per-flow based QoS

Our analysis actually shows that this approach is not even feasible in its current form. A solution is needed that not only enables end-to-end secure communication that is compatible with NAT, but with other networking and QoS protocols. The solution must address two important issues:

There should be a mechanism at the receiver side that enables it to reverse the effect of NAT at the sender side

The packet format should be such that NAT operation must not damage the packet to the extent that the receiver side cannot repair it

### SUMMARY OF THE INVENTION

I present a new method and apparatus for end-to-end secure data communication in LANs, VPNs, and in network-to-network connections. The invention solves many difficult problems faced by the existing secure communication protocols. In addition to achieving the compatibility with NAT, ICMP, and many QoS protocols, the invention also offloads the bulk of the encryption/decryption to the end host. This results in a big reduction in computational load on the gateway/router while providing an integrated solution for end-to-end security in LANs and over public networks.

In this invention, I use methods and protocols where the transport and IP layer headers of an IP packet are visible in the clear, which is a strong requirement for compatibility with NAT. The encrypted payload is the transport layer data, with or without the transport layer header. If the transport layer header is part of the encrypted payload, then a new transport layer header is added. Since in applications like FTP, even the body of certain control messages is affected by NAT and must be visible in the clear. I treat all control messages or packets (including the ones used to open TCP connections) differently from the data packets. The control packets are decrypted at the gateways and re-encrypted after NAT to achieve complete compatibility with NAT. The data packets are encrypted at the end hosts and not decrypted at the gateways. Because the IP and transport layer headers are visible in data packets also, they maintain compatibility with NAT, ICMP and many QoS protocols.

In addition to making all/part of the IP packet visible in the clear so that NAT can function properly, there are situations that require complete or partial reversal of the effect of NAT on an IP packet. For example, NAT uses IP masquerading to hide the local source IP address by changing the source IP address and the port number. A VPN connection requires that the end host are able to see each others internal IP address and Internet key exchange (IKE) also requires that node identifiers (which can be IP address or port numbers) must not be changed as they are protected by a secure hash. Therefore, a mechanism to counter full/part of the effect of NAT on the packet is required. Either in band signaling or out of band signaling can be used.

I solve this problem by duplicating the information, that is affected by NAT, in the control IP packets. This approach is called in-band signaling and later we will explain the out-of-band signaling method as well. The information can be duplicated by encapsulating the original IP packet with extra headers (IP, transport, and other higher networking layers) or by appending the headers to the IP packet. Generalization of this concept includes appending or including the information in the IP packet in any format. By comparing the modified and original information, the receiving host/gateway can learn about the effect of NAT and can reverse its effect on subsequent packets that do not contain the information in duplicate.

Unlike TCP, which is connection oriented, UDP does not have control packets for establishing a connection. In this method, the first packet in a UDP connection is also treated similar to the control packets in a TCP connection. Since there is not mechanism in the UDP protocol to guarantee the packet delivery, we will use a three-way handshake to ensure the delivery of the first packet.

Typically separate secure channels are used for communicating the control and data packets because the control packets are decrypted at the gateways. This creates extra overhead of establishing security associations and key exchange for the control packets, but is necessary for end-to-end secure communication over the public networks. Since the control packets are few compared to data packets, using a single secure channel for all control packets communication between two hosts can mitigate the extra overhead. In LANs it is possible to use the same secure channel for both because the gateways do not affect these packets.

In addition to securing the contents of the control and data packets, the method also provides a mechanism for triggering the establishment of security association and key exchange. The presence of the control packets is used to identify the attempt to establish a connection and initiate the mechanism to establish the necessary security associations and cryptographic keys. When the end host (or the NIC at the end host) encounters a control packet for which there are no security association and keys, the packet is temporarily held at the end host. The sender host establishes a security association and initiates a key exchange with the receiver host or the gateway. Once such a secure channel for exchange of the control packet is established, the control packet is encrypted and sent. When the receiving host sends back a control packet that completes the establishment of the connection, a new key exchange may be initiated by the end host for that connection (session). The key exchange can also be initiated when the end host encounters the control packet. After successful key exchange and connection establishment, the data packets of that connection are encrypted/decrypted by the end hosts using the shared session key.

There are three possible cases that can be envisioned in end-to-end secure communication systems:

The end-hosts are on the same LAN. This is the “LAN security” case.

The end-hosts are on different LANs, but should be able to see the private IP address of each other. This is the “VPN” case.

The end-hosts are on different LANs and must not be able to see the private IP address of each other. This is the “network-to-network” case.

In the first case, when the two hosts are on the same LAN there will not be a NAT between the two hosts. If a secure channel to communicate the control packets does not exist between the two end hosts, the end host or the NIC at the sender host will initiate a key exchange upon encountering a control packet. Another key exchange, for the data packets of that connection may be initiated at that time or after the connection is established, i.e., a control packet is received in response to the one that was sent. After establishing the security associations and cryptographic keys, the end hosts can encrypt all data packets before transmitting it. The packet gets decrypted when it reaches the destination, thus we have established an end-to-end secure communication in a LAN.

In the second case, the two end hosts are on different LANs, but must be able to see each other's private IP addresses. I add extra transport and IP layer header to the packet so that one set of headers is not affected by NAT. The duplicate headers either encapsulate the old packet or are appended to it. NAT performs the IP address and port number translation on the outer IP and transport layer headers while leaving the original or duplicate header untouched. In case of applications like FTP, we would have to duplicate the transport layer data as well if the extra headers encapsulate the original packet. After NAT is performed, the packet is encrypted and sent to the destination gateway. When this packet reaches the destination gateway, the destination gateway decrypts the packet and generates the two 5-tuples of source/destination IP/port numbers and transport layer protocol from the outer and inner headers.

Subsequent data packets need not have extra IP and transport layer headers like the control packets. These data packets are encrypted at the source host and NATed at the source gateway. The destination gateway performs the reverse NAT by comparing the stored 5-tuple pairs with the 5-tuple obtained from the header of the incoming packet. In this scheme, for every connection, the gateway is involved only in the encryption and decryption of the first/control packets. After that all the encryption and decryption is done by the end-hosts and the gateway only performs NAT or reverse NAT.

In the third case, the two hosts are on different LANs and each LAN has a NAT equipped gateway that the data packets must traverse. The control packets sent by the end hosts to their local gateways are decrypted, NATed, and re-encrypted with the security associations and keys shared by the gateways. At the receiving gateways the control packets are decrypted, NATed, and encrypted with the SAs and keys that the receiving gateway and end host share. For the data packets, the gateways only perform the NAT operation.

The key exchange, for the data stream, between the two end hosts is more complex. For example, if we use IKE [11], the end hosts cannot pass their IP addresses as node identifiers because NAT traversal will require modifications to the body of the message, which is protected by a hash. A possible solution is that the gateways perform the key exchange and then share them with the end host. This is cumbersome and has potential to significantly increase the load on the gateways. It also requires that part of the packet affected by NAT must not be included in the AH and may not work in case of non-static port mapping. In my method, we can use the port numbers as node identifiers and the end hosts can perform the key exchange. In one approach, I duplicate the port number information in the control packets by adding extra transport layer header. The end host can learn about the effect of NAT on the connection and can reverse it for subsequent packets where the information is not duplicated. This is similar to the VPN approach.

Another approach is to encapsulate the transport layer data and header with another transport layer header in order to protect it from NAT. Now only the outer transport layer header will get modified while the internal transport layer data and packet will be left intact. The receiving host uses the port numbers from the inner transport layer header, which are static and known, as the node identifiers in IKE based key exchange. The receiving end host maintains a 3-tuple pair of source IP address and source/destination port numbers from the two transport layer headers. This 3-tuple is used to correct the port numbers of the outgoing packets. After the key exchange in done, the data packets are encrypted using the SAs and keys shared by the end hosts. The two gateways only perform NAT on these packets. The data packets are decrypted at the receiving end host and we have end-to-end security for control and data packets.

### BRIEF DESCRIPTION OF THE DRAWINGS

FIG. 1 describes a configuration for secure data communication over a LAN channel 5 that is not secured. At each end host 1, 9 there is a resource (encoding device) 4, 6 that encrypts/decrypts the data DA/DB 3, 7, using a key KA/KB 2, 8, to produce cipher text EA/EB 11, 10. The end hosts have to share one or more keys that will be used to encrypt and decrypt the messages.

FIG. 2 describes another configuration where two hosts are located on different LANs. Their communication takes place over the public channel 19 that is not secured. The data or plain text 13, 24 located on the stations 12, 26 traverses through the LAN 16, 22; the gateways 17, 21; and the Internet 19. In a VPN configuration the two stations 12, 26 will be able to see each other's IP addresses. In a network-to-network configuration, the stations 12, 26 will be able to see only the IP address of the gateways 17, 21.

FIG. 3 shows the seven layered open systems interconnect (OSI) model for networking. The data 29 from user 28 is packaged by each networking layer 30, 31, 32, 33, 34, 35, and 36 by adding its own header and passing it over to the next networking layer. The data travels over the network 37 and is processed again by the OSI stack. This time each layer strips its header and passes the data over to higher layer. After all the network layers have processed the data, it reaches the user 27.

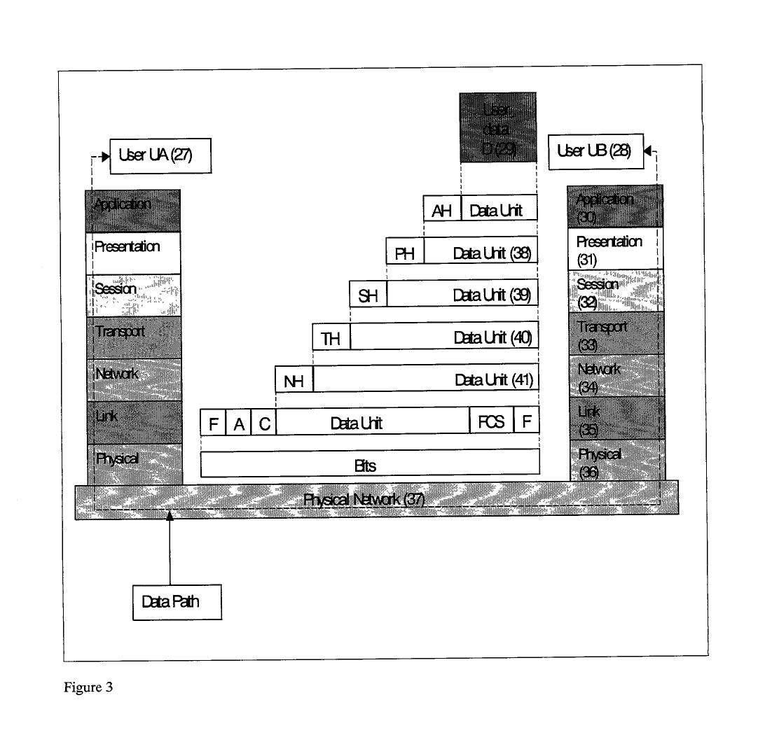

FIG. 4 a) shows the original IP packet 42 with the IP header 43, TCP/UDP header 44, and the TCP/UDP data 45. An option for secure communications b) 46, is to encrypt the transport layer data 51 and craft a new packet by adding ESP header 50, Authentication header (AH) 49, TCP/UDP header 48, and the IP header 47. This approach is similar to that used in SSL/TLS. Another option c) 52, is to encrypt the transport layer header 57 as well as the data 58 and craft a new packet by adding the ESP header 56, AH 55, a new transport layer header 54, and IP layer header 53 to it. This approach is designed by us and termed “TCPSec”. TCPSec packet helps protect tempering to the transport layer header that is encrypted. In a TCPSec formatted packet, the outer transport layer header can be discarded after the packet is decrypted or a crosscheck can be performed if the receiver has means to reverse the effect of NATs on the outer transport layer header.

FIG. 5 illustrates the structure of the control packets d) 75, e) 83 transmitted over the public networks in a VPN connection. NAT is performed on modified packets b) 63, c) 69. Extra headers 64, 65 may either encapsulate the original packet 59 or the extra headers 73, 74 are appended to the packet original packet. After NAT is done, these modified packets are encrypted 75, 83 and transmitted over the public networks.

FIG. 6 illustrates the structure of the new control packets d) 105, e) 112 transmitted over the public networks in a network-to-network connection. NAT is performed on modified packets b) 95, c) 100. The extra transport layer header 97 may encapsulate the original transport layer data 99 and header 98. The control packet can also be modified where the extra header 104 is appended to the packet. After NAT is done, these modified packets are encrypted 105, 112 and transmitted over the public networks.

FIG. 7 shows a simplified pseudo-code that describes the steps that are taken at the end-hosts A 1, 12 and B 9, 26 to process outbound/incoming IP packets.

FIG. 8 shows a simplified pseudo-code that describes the steps that are taken at the gateways GA 17 and GB 21 to process the inbound/outbound control packets. The control packets are treated differently in order to provide end-to-end security over public networks.

FIG. 9 shows a simplified pseudo-code that describes the steps that are taken at the gateway GA 17 and GB 21 to process transport layer data packets in a VPN and network-to-network connection that is end-to-end secure.

FIG. 10 shows additional simplified pseudo-code that describes the extra steps that are taken at the end hosts A 12 and B 26 to process the data and control packets in an network-to-network connection that is end-to-end secure.

### DESCRIPTION OF THE PREFERRED EMBODIMENT

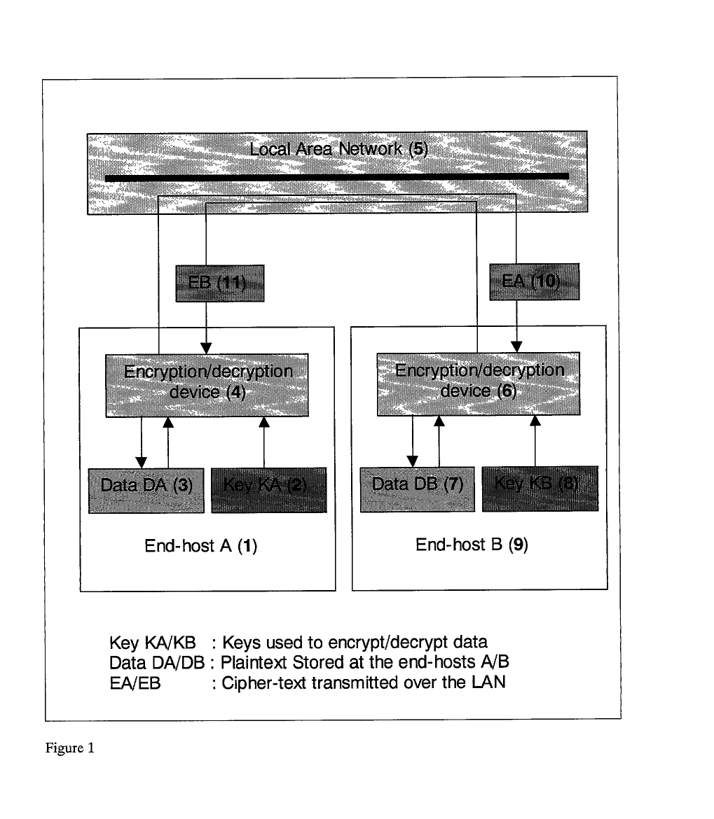

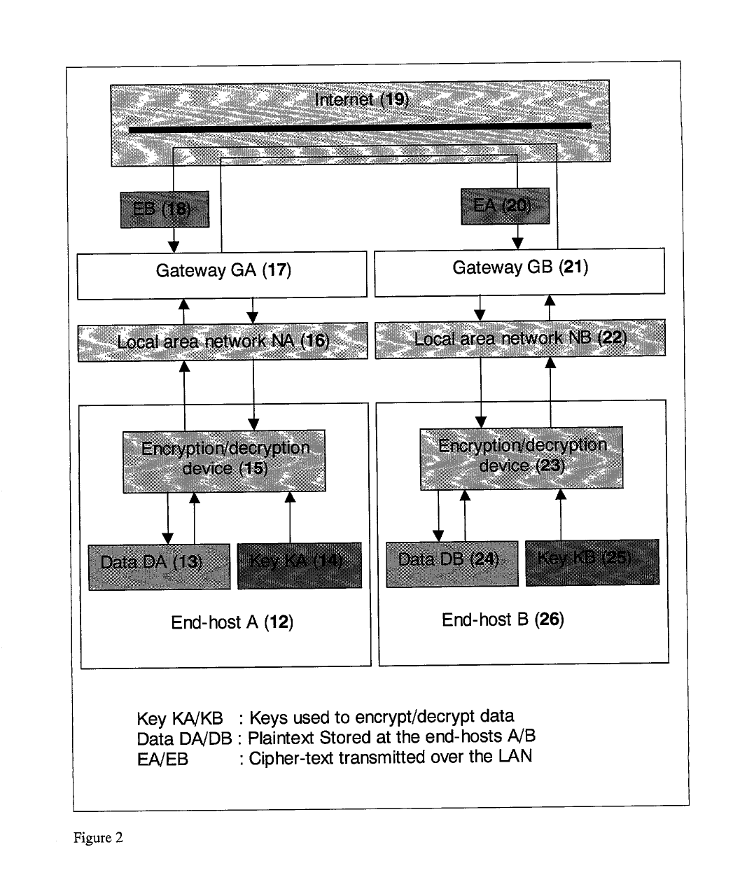

There are three possible scenarios for end-to-end secure communication that arise from two different physical configurations between two end hosts A 1, 12 and B 9, 26. These three scenarios are host-to-host communication over a LAN, host-to-host communication over a public network and host-to-host communication over a public network that should appear like a LAN communication (VPN). In the first configuration (FIG. 1), both hosts are on the same local area network (LAN) 5. In the second configuration (FIG. 2), they are on different LANs 16, 22 that are connected together by a public network such as the Internet 19. It is the second configuration that has to be treated carefully because of presence of NAT. In this section I will explain how the preferred embodiment solves the end-to-end secure communication is all three scenarios while maintaining compatibility with NAT. Our preferred embodiment is also compatible with ICMP and all other networking and QoS protocols that operate up to layer four in the OSI stack.

In any network communication, there are control packets that signify an attempt to open a communication or the beginning of a communication. For example, the TCP protocol uses exchange of control packets between two hosts to establish a connection. The SYN-bit of the TCP header, that is set to one, can be used to easily identify these packets. Only after the connection is established can the two hosts actually send data to each other. However, in UDP there is no concept of opening and closing a connection. There, the very fist UDP packet can be used to signify the beginning of a connection. Henceforth, I shall refer to these packets as the “control” packets. I give special treatment to these control packets in order to provide end-to-end secure communication in all possible scenarios. These scenarios are LAN communication (first scenario), VPNs (second scenario), and network-to-network connection (third scenario).

Control packets are decrypted at the gateways to ensure NAT compatibility and re-encrypted before they are sent to the receiving gateway or end host. Moreover, some information in the control packets is duplicated to enable the receiving gateway or end host to understand the effect of NAT on the connection. This information can be used later to reverse the effect of NAT.

If the security associations and cryptographic keys for securing the contents of the data packets of this new connection do not exist, then they too must be established and the presence of control packets can be used as a trigger. After the security associations and cryptographic key have been established the data packets of this new connection can be encrypted at the sending host and decrypted at the receiving host. Now I will describe in more detail how this concept will work in the two configurations that give rise to three scenarios for end-to-end secure communication.

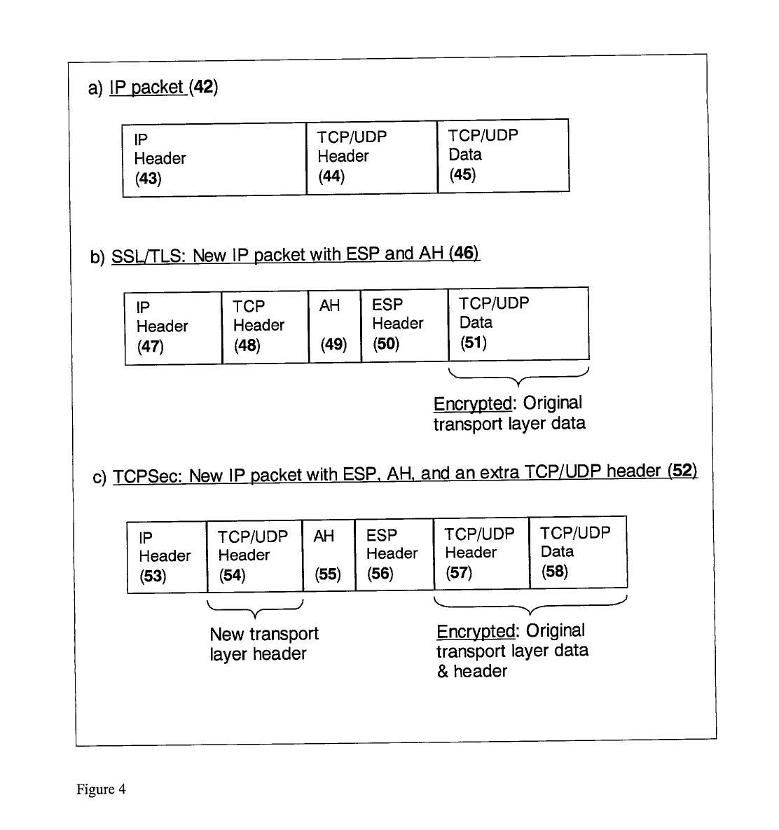

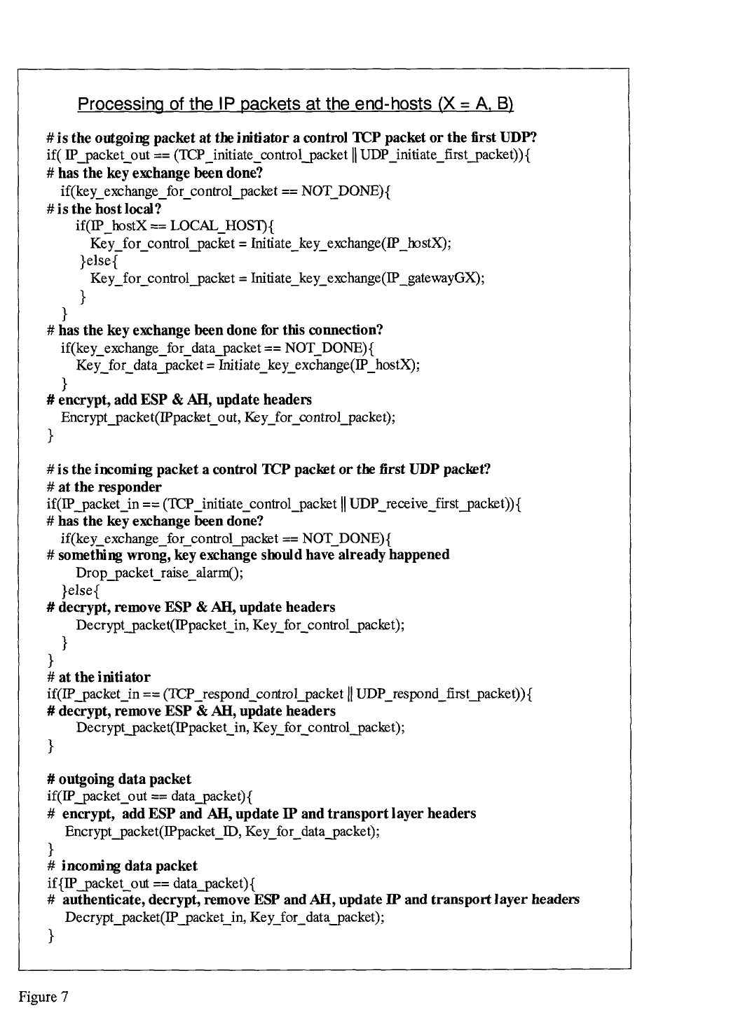

Consider the first scenario that arises from the first configuration, as shown in FIG. 1. The pseudo-code that describes the processing of various data and control packets to achieve end-to-end security is outlined in FIG. 7. In this configuration it is not necessary to give special treatment to the control packets as the packets are not affected by NAT. When an IP packet is encountered (e.g., by the network interface card (NIC) 4, 6) for which there are no security associations (SAs), but the security policy requires a SA, a key exchange is initiated with the other host. If the SA and cryptographic keys already exist, or after the key exchange is done, the contents of the control/data packets are encrypted before transmitting it. FIG. 4 shows two possible ways, b) 46 and c) 52, to encrypt the contents of the control packet and craft a new IP packet.

In b) 46, we encrypt only the transport layer data 51. The new IP packet 46 is crafted by adding the ESP header 50, AH 49, transport layer header 48, and the IP header 47. The only difference between the new 48 and old 44 transport headers is the checksum field. Similarly, the only difference between the new 47 and the old 43 IP headers is the length field. When the IP packet reaches the destination end host, it gets authenticated, decrypted. The encapsulated security payload (ESP) header 50 and authentication header 49 (AH) are removed, the checksum filed in the transport layer header 48, and the length and checksum fields in the IP header 47 are updated. Now the IP packet looks exactly like the original IP header. This is similar to SSL/TLS approach. Here, the authentication header 49 does not protect the port numbers and IP addresses.

In c) 52, the transport layer header 57 and the data 58 are encrypted. The new IP packet is crafted by adding the ESP header 56, AH 55, new transport layer header 54, and the IP header 53. This particular method of packaging the packet is termed as “TCPSec” (or “UDPSec”) by us. Advantage of TCPSec c) 52, over SSL/TLS b) 46, is that it makes it possible to protect the port numbers against tempering. The outer transport layer header can be discarded after the packet is decrypted or a crosscheck can be performed if the receiver has means to reverse the effect of NATs on the outer transport layer header. In addition, it can also provide some protection against the tempering with the IP address through the checksum field in the transport layer header 57.

In the second configuration (FIG. 2), the hosts A 12 and B 26 are on different LANs 16, 22 that are connected together by a public network such as the Internet 19. The operation of the end hosts remains exactly the same as in the first configuration. The gateways, GA 17 and GB 21, help in establishing the secure link between the two end hosts A 12 and B 26 over the public network 19. The remaining two scenarios arise in this configuration:

The second scenario is a “VPN,” where the hosts on either LAN can directly communicate with a host on the other LAN.

The third scenario is a “network-to-network” connection, where the hosts on the two LANs have the knowledge of the IP address of the gateways, but not of each other's internal IP address.

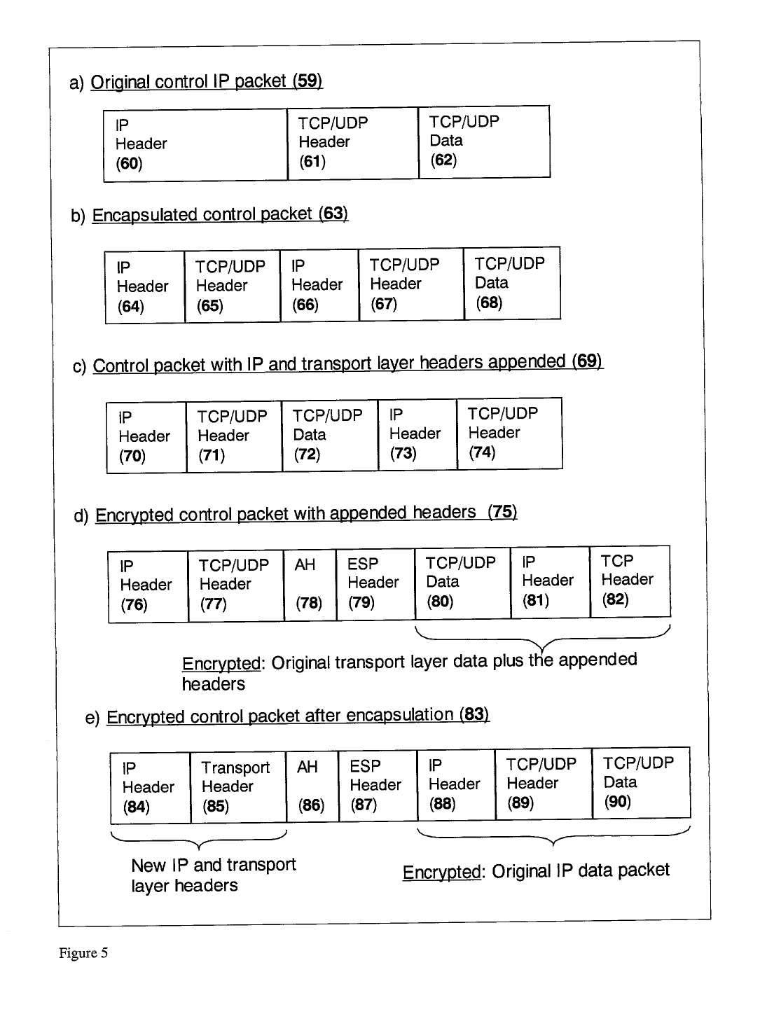

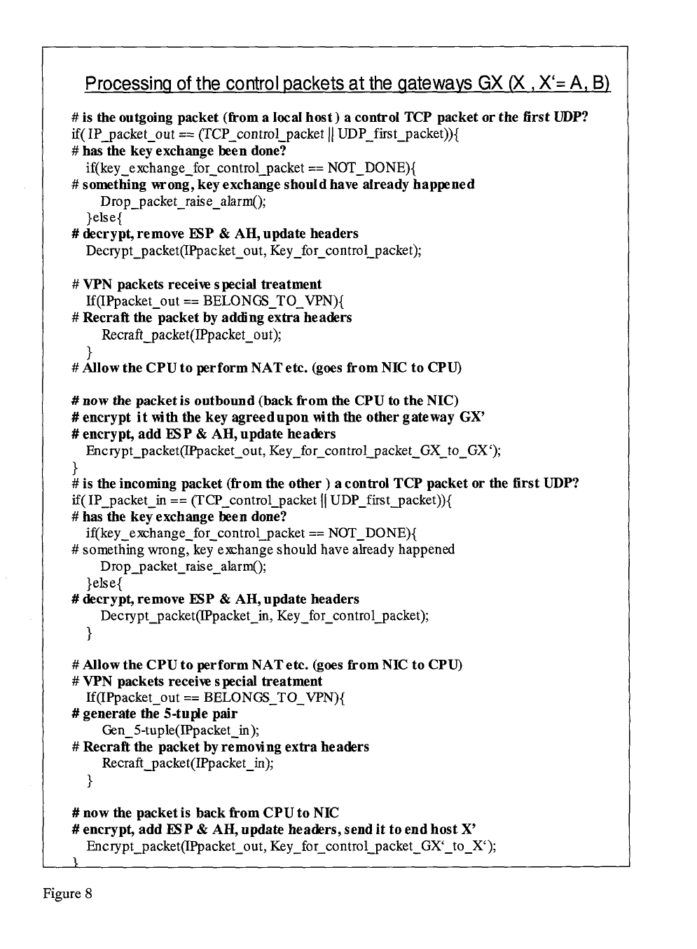

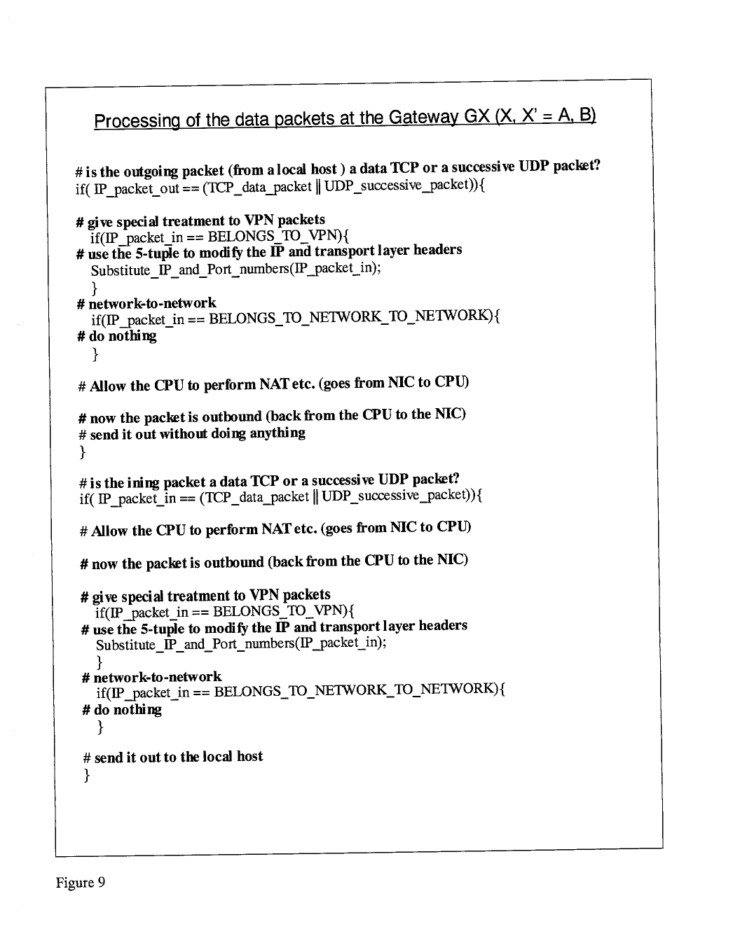

In the second scenario, which is a VPN, the two end hosts should be aware of each others IP address even when their IP addresses are not public IP address. This is achieved by duplicating the IP address and transport layer port number information in the control packets. Since this information is contained in the IP and transport layer headers, one can either append these headers to the IP packet or encapsulate the original IP packet using the extra headers. FIG. 5 shows how the modified packets b) 63, c) 69 may look like on which NAT is performed. The NAT will only modify the information contained in outer headers so that the packet can traverse the public networks and the end host or gateway can observe the effect of NAT on the connection by comparing the modified and unmodified headers. In the subsequent data packets, the headers are not duplicated and this information can be used to reverse the effect of NAT. FIG. 7, FIG. 8, and FIG. 9 outline the pseudo-code explaining the procedure for secure end-to-end communication in a VPN.

Upon encountering the control packet, the end host A 12, or the NIC 15, processes it in an identical manner it would process control packets going to end hosts on the same LAN. Since the destination is not on the same LAN, the control packet is encrypted using SAs and keys shared by the end host A 12 and the gateway GA 17. When the control packet arrives at the gateway GA 17, it is decrypted and additional IP and transport layer headers are added which either insulate the original IP packet from NAT b) 63 or are themselves insulated form the NAT c) 69. The gateway performs NAT on this new packet and modifies the outer IP 64, 70 and transport 65, 71 layer headers. The information contained in the inner transport 67, 74 and IP headers 66, 73 remains unaffected. The gateway GA 17 sends the control packet to gateway GB 21 after encrypting d) 75, e) 83 using the SAs and cryptographic keys that have been established between them for this channel.

When the new IP packet d) 75 or e) 83 reaches the gateway GB 21, it is decrypted. A pair of 5-tuple is generated on the basis of the two pairs of IP (76, 81 or 84, 88) and transport (77, 82 or 85, 89) layer headers contained in this packet. The 5-tuple contains the source IP address, destination IP address, source port number, transport protocol, and the destination port number. The gateway GB 21, strips off the extra IP and transport layer headers, encrypts it, and sends the original control packet to the end host B26.

After establishing the connection or when the control packets are first encountered, the end host A 12 also initiates the process to establish SAs and exchange keys for securing the data packets. The subsequent data packets sent by host A 12 are not affected by the gateway GA 17, except for NAT performed on them. These data packets are encrypted by the end host A 12 using security associations and cryptographic keys shared between the end hosts A 12 and B 26. When these data packets reach the gateway GB 21, their headers are manipulated based on the 5-tuple pair to reflect the IP addresses of the end hosts. Thus the packet that reaches host B is the exact same packet that was sent out by the host A and contains IP addresses in its header that were never visible on the Internet. FIG. 9 outlines the pseudo-code for the processing of the data packets at the gateways GA 17 and GB 21.

The method works even when the gateways have non-static port mapping, i.e., the source port number in the data packet may be suddenly changed by the gateway. This could be a problem for connectionless transport layer protocols like the UDP. The gateway cannot change the source port number in a TCP connection and non-static port mapping is not a problem for end-to-end secure TCP connection. This however, has no adverse affect in my method. If the gateway GA 17 decides to remove the mapping for a particular secure connection or stream, then the next packet from that stream will automatically trigger the response that gateway has for the first or control packet of any connection. The packet will have extra IP and transport layer headers added to it, NATed, encrypted, and sent over the receiving gateway GB 21. The gateway GB 21 will decrypt the packet, update the 5-tuple pair, and send it to end host B 26. The 5-tuple pair can also be created by looking up the security association in the incoming packet.

The fundamental concept behind encapsulating/appending the headers to the IP packet is that it allows us to observe the effect of NAT on the IP packet. For most applications, only the IP and transport layer headers are modified by NAT. However, in FTP protocol, the body of the transport layer data is also modified. In that case, the encapsulation process includes addition of the transport layer data to the extra transport and IP layer headers. The new packet looks similar to two old IP packets concatenated together.

Consider the third scenario, when the two end hosts are not (and should not be) aware of each other's internal IP addresses. We desire end-to-end secure connection in this scenario as well, even though this is a network-to-network connection. If the key exchange is done manually or by the gateways and the end hosts do not participate in it, then the solution is simple. The end host A 12 sends the control packet to the gateway GA 17 using the security associations and keys that they share for exchanging control packets. At the gateway GA 17 the control packet is decrypted and NAT is performed. The gateway GA 17 sends the packet to gateway GB 21 by encrypting it using the security associations and keys that they share for exchanging control packets. The gateway GB 21 decrypts the packet and performs another NAT to direct this packet to a local host, e.g., local host B 26. It sends the control packet to the end host B 26 after encrypting it using the security associations and keys that they share for exchanging control packets. Hence, we have a method for end-to-end secure communication of the control packets. For the data packet, the end host A 12 encrypts them with SAs and keys it shares with the end host B 26 and sends them to the gateway GA 17. The gateway GA 17 performs NAT and forwards the data packet to the gateway GB 21. The gateway GB 21 performs another NAT and forwards the packets to the end host B 26, where they get decrypted.

However, key exchange that is done manually or by the gateways is not as convenient compared to the situation when the two end hosts A 12 and B 26 can establish the security associations and keys themselves. Popular key exchange methods such as the IKE are not compatible with NAT and that would prevent the end hosts from engaging in SA negotiation and key exchange. For the purpose of establishing security association and key exchange, the end hosts cannot use their IP addresses as node identifiers. This problem can be overcome by not using the pre-shared key mode of IKE or by using the aggressive mode.

After the security associations have been established and key exchange is done, we need a mechanism to direct the subsequent packets to the correct end host and enable the end host to perform the majority of encryption and decryption. The end host can be uniquely identified by the source IP address, security parameter index, and source port number of the data packet. The gateway can use the source IP address and security association to direct the packet to the right end host on its network. However, there is a finite probability of collision as two hosts behind the NAT may end up selecting same security association.

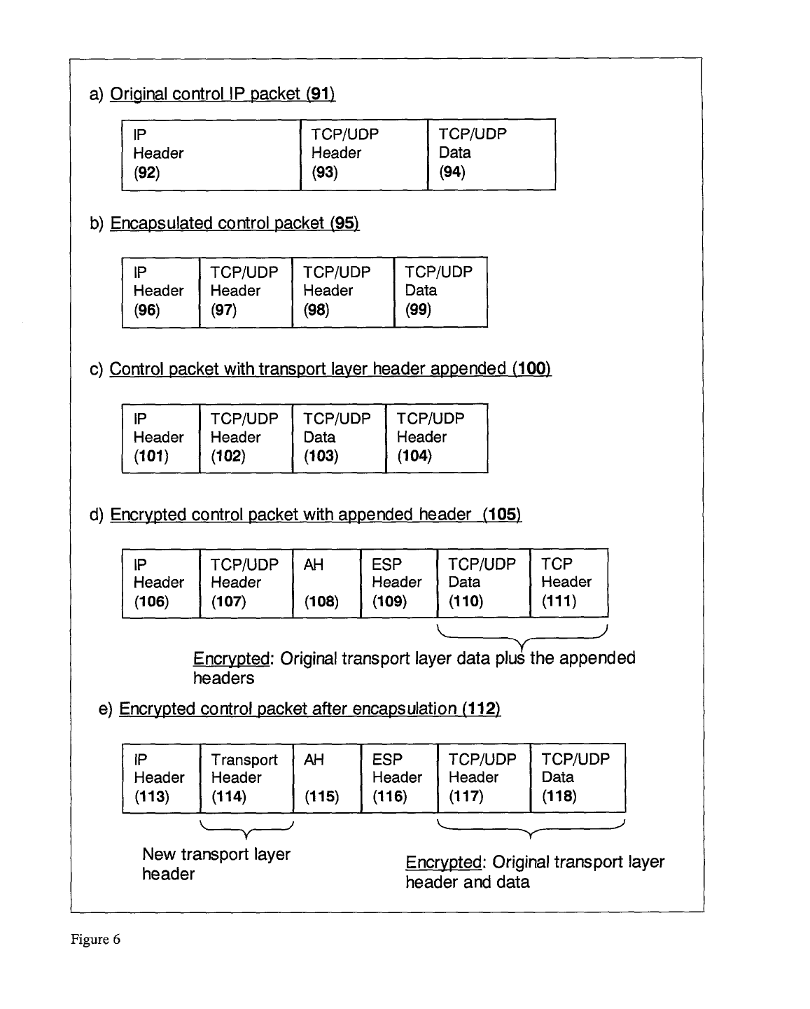

If the encryption/decryption is done at the end host, we still have to either protect the transport layer header from NAT or have the ability to reverse the effect of NAT. I achieve this by information duplication method used in the second scenario. Here only the transport layer header information is duplicated. As shown in FIG. 6, an extra transport layer header is either appended c) to or encapsulates b) the transport layer header and data. The NAT will only modify the information contained in outer transport layer header and the end host or gateway can observe the effect of NAT on the connection by comparing the modified and unmodified headers. In the subsequent data packets, the headers are not duplicated and this information can be used to reverse the effect of NAT.

The end host A 12 processes it in exactly the same fashion it processes control packets going to end hosts on the same LAN. Since the destination is not on the same LAN, the control packet is encrypted using SAs and keys shared by the end host A 12 and the gateway GA 17. When the control packet arrives at the gateway GA 17, it is decrypted and extra transport layer header is added. As shown in FIG. 6 b) 95, extra transport layer header 97 encapsulates the original transport layer header 98 and data 99. Similarly, FIG. 6 c) 100, the extra transport layer header 104 can also be appended to the transport layer header 102 and data 103. The gateway performs NAT on this new packet and modifies the outer IP and transport layer headers. The information contained in the inner transport header remains unaffected. The gateway GA 17 sends the control packet to gateway GB 21 after encrypting d) 105, e) 112 using the SAs and cryptographic keys that have been established between them for this channel.

When the encrypted IP packet 105, 112 reaches the gateway GB 21, it is decrypted and another NAT is performed on it. The gateway GB 21 encrypts it and sends it to the end host B 26. The end host B 26 decrypts the packet and generates a 3-tuple pair by comparing the information contained in the modified headers and the unmodified header.

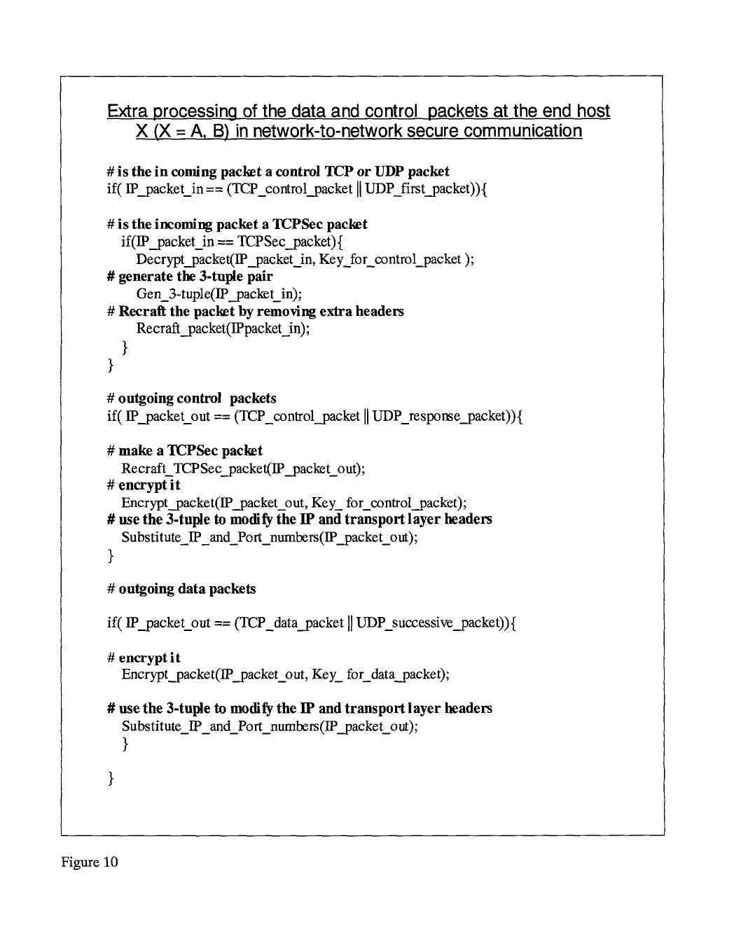

After establishing the connection or when the control packets are first encountered, the end host A 12 also initiates the process to establish SAs and exchange keys for securing the data packets. The subsequent data packets sent by host A 12 are not affected by the gateways GA 17 and GB 21, except for NAT performed on them. These data packets are encrypted by the end host A 12 using security associations and cryptographic keys shared between the end hosts A 12 and B 26. When these data packets reach the end host B 26, their headers are manipulated based on the 3-tuple pair to reflect the original port numbers. The end host B 26 also manipulates the port numbers in headers of outgoing data packets, on the basis of the 3-tuple pair, so that the gateway GB 21 can forward them correctly. FIG. 9 outlines the pseudo-code for the processing of the data packets at the gateways GA 17 and GB 21. FIG. 10 outlines the extra pseudo-code that is required to process the data and control packets at the end hosts in a network-to-network connection.

This approach for end-to-end security in a network-to-network connection is based up reversing the effect of NAT. Another approach to solving this problem is to shield the data/control packets from NAT. This can be done by encapsulating the transport layer header and data with another transport layer header. This does add the overhead of an extra header, but it has added benefit of protecting the port numbers from tempering and improves resistance against denial of service attacks (DoS). This type of packet format is identical to the TCPSec 52 packet format. Another advantage of this approach is that the gateways can treat the control packets just like the data packets and do not have to decrypt and re-encrypt them.

The initiating end host A 12, crafts a packet in a manner depicted in FIG. 4 c) 52. The checksum for the inner transport layer packet is computed by either replacing the IP addresses in the pseudo-header by zero or by a number known to both A 12 and B 26. This packet is encrypted by end host A 12, using SAs and keys that it shares with the end host B 26, and sent to the gateway GA 17. The gateway GA 17 performs NAT and forwards the packet to gateway GB 21. The gateway GB 21 performs another NAT and forwards this packet to the end host B 26. FIG. 10 outlines the pseudo-code for processing the control and data packets at the end hosts A 12 and B 26. The end host B 26 decrypts the packet and makes a 3-tuple pair on the basis of the port numbers in the inner 57 and outer 54 transport layer headers and the source IP address. This information is later used to insert the correct port number in the packets that the end host B 26 sends to the end host A 12. The extra transport layer header 54 is removed and the checksum of the inner transport layer header 57 is updated to reflect the correct source and destination IP address contained in the IP header. The IP header is also updated to show the correct length of the decrypted packet. Now the port numbers in the packet reaching the end host B 26 are identical to the ones in the packet send by the end host A 12.

### References

[1] H. Zimmerman OSI reference model—The ISO model of architecture for open systems interconnection. IEEE Transactions on Communication COM-28(4): 425-432, April 1980.

[2] Secure Socket Layer (SSL) Protocol V3.0: http://www.netscape.com/eng/ss13/ssl-toc.html

[3] The Transport Layer Security (TLS) Protocol Version 1.0-RFC 2246

[4] HTTP over TLS-RFC 2818

[5] Security Architecture for Internet Protocol (IPSec)-RFC 2401

[6] The IP Network Address Translator (NAT)-RFC 1631

[7] Traditional IP Network Address Translator (Traditional NAT), Internet draft http://www.ietf.org/internet-drafts/draft-ietf-nat-traditional-04.txt

[8] Internet Control Message Protocol (ICMP)-RFC 792

[9] Realm-Specific Internet Protocol (RSIP) Internet draft, draft-ietf-nat-rsip-framework-05.txt

[10] IPSec NAT-Traversal Internet draft: draft-stenberg-ipsec-nat-traversal.txt

[11] The Internet Key Exchange (IKE). D. Harkins, D. Carrel. November 1998: RFC2409

[12] Mayes, John C. and Coile, Brantley W. “Security System for Network Address Translation,” U.S. Pat. No. 5,793,763, Aug. 11, 1998.

What is claimed:

1. A method for duplicating information in an IP packet with the sole intention of using it to partially or completely reverse the effect of intermediate NATs, comprising the steps of:
Identifying parts of an IP packet that can be potentially modified by NATs;
Copying that information in its current form or copying it into a different format;
Inserting this information into an IP packet in a manner that keeps it protected from intermediate NATs.

2. The method of claim 1 wherein complete IP header and the transport layer header is inserted into the IP packet. Such a packet will have duplicate IP and transport layer headers or a duplicate IP or transport layer header.

3. The method of claim 1, wherein the duplicate information is inserted into the IP packets of the same connection in a manner that keeps it protected from intermediate NATs.

4. The method of claim 1, wherein the duplicate information is inserted into the IP packets of a different connection. In addition, there are identifiers inserted into the IP packets of both connections to correlate them.

5. A method for studying the effect of intermediate NATs with the sole purpose of using it to partially or completely reverse the effect of intermediate NATs, comprising the steps of:
Identifying parts of an IP packet that can be potentially modified by intermediate NATs;
Identifying parts of an IP packet from same or different connections that contain information before intermediate NATs modified it;
Generating a look-up table that signifies the effect of intermediate NATs on the IP packets of that connection.

6. A method for reversing partially or fully the effect of intermediate NATs based on a look-up table that signifies the effect of NATs on the IP packets of that connections.

7. The method of claim 6 wherein only the effect of NAT on the transport layer header is reversed.

8. The method of claim 6 wherein only the effect of NAT on the IP header is reversed.

9. The method of claim 6 wherein the effect of NAT on the transport layer data is reversed.

10. A method for correcting the information in outgoing IP packets so that they arrive in a state expected by the NATs.

11. The method of claim 10 where the IP header and/or the transport header of the outgoing packet is modified.

12. The method of claim 10 where the body of the outgoing packet is modified.
